(19) United States
(12) Patent Application Publication
(10) Pub. No.: US 2010/0103274 A1
(43) Pub. Date: Apr. 29, 2010

(54) Image distortion compensation method and apparatus

(75) Inventor: Dae Woong Kim, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/589,603

(22) Filed: Oct. 26, 2009

(30) Foreign Application Priority Data
Oct. 27, 2008 (KR) 10-2008-0105422

(51) Int. Cl. H04N 5/222

(52) U.S. Cl. 348/208.4; 348/E05.022

(57) ABSTRACT

A camera module includes an image distortion compensation apparatus configured to perform a method for compensating the image distortion caused by a sensor movement. A method of compensating an image distortion includes receiving an image including distortion caused by an movement of a sensor in a mode where two or more successive images are received. The method further includes calculating variation information using a relation between corresponding points of the received image (current image) and an adjacent image (previous image) which was previously received; and compensating the distortion included in the current image by making use of the variation information. The calculating variation information includes: calculating an actual homography value between the current image and the previous image; setting up the calculation based homography value including the variation information; and obtaining variation information having a minimum difference between the actual homography value and the calculation based homography value.

### CROSS-REFERENCE TO RELATED APPLICATION(S) AND CLAIM OF PRIORITY

The present application is related to and claims priority to an application entitled “IMAGE DISTORTION COMPENSATION METHOD AND APPARATUS” filed in the Korean Intellectual Property Office on Oct. 27, 2008 and assigned Serial No. 10-2008-0105422, the contents of which are incorporated herein by reference.

### TECHNICAL FIELD OF THE INVENTION

The present invention relates to image distortion compensation, and more particularly, to a method and apparatus for compensating the image distortion caused by a sensor movement, that is, caused by moving.

### BACKGROUND OF THE INVENTION

Generally, a camera sensor taking a picture of image is divided into a Charge Coupled Device Sensor (CCD sensor) and a Complementary Metal Oxide Semiconductor image sensor (CMOS sensor). As to the image photographing method of the sensors, the charge coupled device sensor simultaneously stores data (Intensity) of all pixels within image inputted through sensor, whereas the complementary metal oxide semiconductor sensor stores the image inputted through the sensor in a successive time with a line unit.

In other words, in the image photographing of one frame, the charge coupled device sensor simultaneously stores all pixels in the same time point with respect to the entire inputted image. Additionally, the complementary metal oxide semiconductor sensor stores a corresponding image according to the order of reading that is stored depending upon the location of pixel in the inputted image such that a certain gap is found between a pixel which is read and a pixel which is read later as the exposure time of image is successively delayed. Therefore, when the image photographing by the terminal that includes a complementary metal oxide semiconductor sensor, in particular, when the image photographing is performed according to the sensor movement, the photographed image includes a distortion. That is, when photographing while moving a camera that includes a complementary metal oxide semiconductor sensor, the photographed image includes distortion according to the traveling direction and speed.

For example, when photographing a pillar that stands perpendicular to the surface while moving the camera, mounting a complementary metal oxide semiconductor sensor, to the right, the perpendicular pillar in the photographed image is distorted in such a manner that the pillar inclines diagonally. A panoramic shot is representative photography that accompanies such moving. Panorama is a technology that expresses the whole view of the wide angle in one photo image by using a plurality of images consecutively photographed while rotating to one side direction around the axis of camera. This panorama shot function is one of functions basically equipped in a plurality of terminals that include a camera function. In case a terminal that includes a CMOS sensor takes a picture of an image by using a panorama function, the images that are inputted while moving up and down or right and left include the above-described problems that are caused due to the storage mode of the CMOS sensor, that is, the problem of the distortion caused by moving. Accordingly, in the terminal equipped with the CMOS sensor, a method capable of successive photographing image having no distortion is required.

### SUMMARY OF THE INVENTION

To address the above-discussed deficiencies of the prior art, it is a primary object to provide a method and apparatus for compensating an image distortion caused by moving.

In accordance with an aspect of the present invention, a method of compensating for an image distortion includes: receiving an image including distortion caused by an movement of a sensor in a mode where two or more successive images are received; calculating variation information by making use of a relation between corresponding points of the received image (current image) and an adjacent image (previous image) that previously was received; and compensating for the distortion included in the current image by making use of the variation information. Calculating the variation information includes: calculating an actual homography value between the current image and the previous image; setting up the calculation based homography value including the variation information; and obtaining variation information that includes a minimum difference between the actual homography value and the calculation based homography value.

In accordance with another aspect of the present invention, an apparatus for compensating for an image distortion includes: a sensor that is configured to scan an image with a temporal interval, in a mode where two or more successive images are received; an image processing unit that is configured to receive an image including a distortion caused by a movement of the sensor and to process the distortion image with a frame unit; an image processing controller that is configured to calculate variation information by making use of a relation between corresponding points of the received image (current image) and an adjacent image (previous image) that previously was received, and to compensate for the distortion included in the current image by making use of the variation information; and a storage that is configured to store at least one storing requested image, the previous image, the distortion value and the variation information. The image processing controller calculates the variation information by calculating an actual homography value between the current image and the previous image, setting up the calculation based homography value including the variation information, and then, calculating variation information that includes a minimum difference between the actual homography value and the calculation based homography value.

The present invention provides an advantage in that distortion of an image can be compensated by using a homography model in the image that includes the distortion due to the movement of sensor. Moreover, the image degradation of the CMOS sensor causing distortion due to the movement of sensor can be solved by using a software means. Since it can be applied to a consecutive image input, it can be applied to a real-time algorithm. The present invention can obtain panoramic images that do not include distortion by applying the distortion compensation algorithm of the present invention to the panoramic algorithm in which a motion model can be approximated to a basic variation model.

It is to be understood that both the foregoing general description and the following detailed description are exemplary and explanatory and are intended to provide further explanation of the invention as claimed.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a schematic configuration of a camera module compensating distortion of image according to an exemplary embodiment of the present invention;

FIG. 2 illustrates a flowchart of a process of compensating distortion of image according to an exemplary embodiment of the present invention;

FIG. 3 illustrates an exemplary diagram of an image that includes distortion and an image that does not include distortion; and

FIG. 4 illustrates an exemplary diagram of images according to an elapse of time.

### DETAILED DESCRIPTION OF THE INVENTION

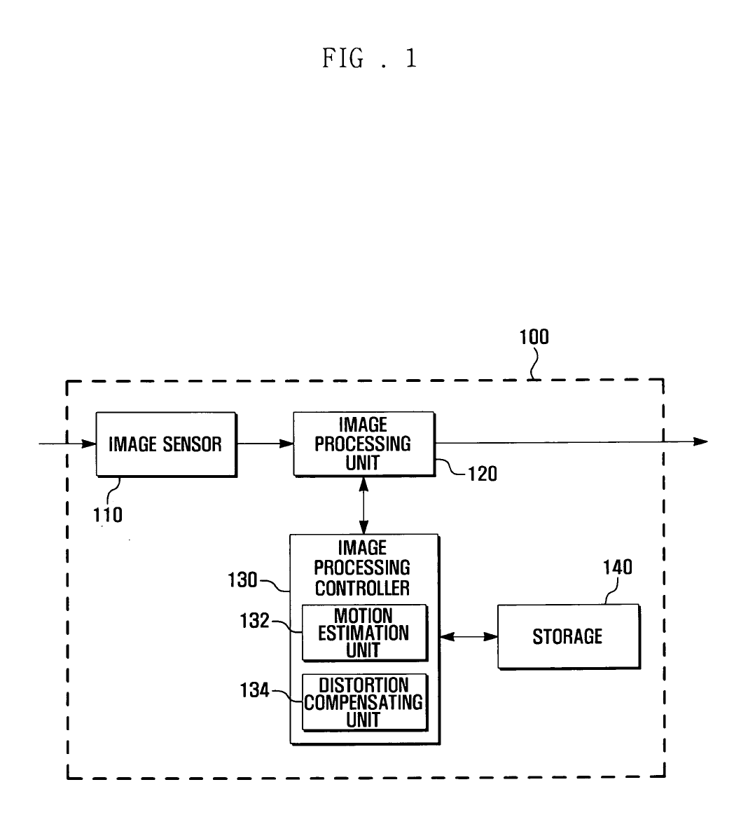

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image capture device.

In the event that a scanned image or other image is distorted due to the movement of sensor, the present invention illustrates an algorithm that compensates for the distortion by using homography between the adjacent images. Generally, homography shows a relation between two images with a matrix while using points corresponding to each other in two images. The apparatus for compensating for distortion of an image is illustrated by applying a distortion compensation algorithm using homography with reference to drawings.

FIG. 1 illustrates a block diagram of a schematic configuration of a camera module compensating distortion of image according to an exemplary embodiment of the present invention.

FIG. 1 shows a camera module 100 that processes an image, however, it should be noted that the present invention can be applied to all terminals equipped with a camera module. For example, the mobile communications terminal can be equipped with a camera module and corresponding configurations can be added according to a relevant terminal. For example, the configurations for the mobile communications function can be added besides the configuration of FIG. 1. Referring to FIG. 1, the camera module 100 can include an image sensor 110, an image processing unit 120, an image processing controller 130, a storage 140. The camera module 100 can be an Image Signal Processor (ISP) or a camera control processor. In an example shown in FIG. 1, the camera module 100 is implemented as a single chip by combing with the image sensor 110, or can be implemented as an independent chip separate from the image sensor 110. The image sensor 110 converts a light signal into an electric signal and outputs. It is assumed that the image sensor 110 of FIG. 1 is a CMOS sensor that scans the image of one frame while having a temporal interval.

As described above, since the CMOS sensor stores a corresponding pixel according to the order of reading that is stored according to the location of pixel in the inputted image. The exposure time of the image is successively delayed so that the image includes a feature such that a regular time interval is found between a pixel which is initially read and a pixel which is read later in the same screen. Such feature causes distortion of image when the movement of sensor is accompanied like the panoramic image photograph. The present invention tries to compensate for such distortion. The detailed description about this is described herein below. The image processing unit 120 generates screen data for displaying an image signal outputted from the image sensor 110 to a display unit (not shown) and outputs. The image processing unit 120 processes the inputted image signal with a frame unit, and outputs adjusting to characteristics and size of the display unit when processing the image signal with a frame unit.

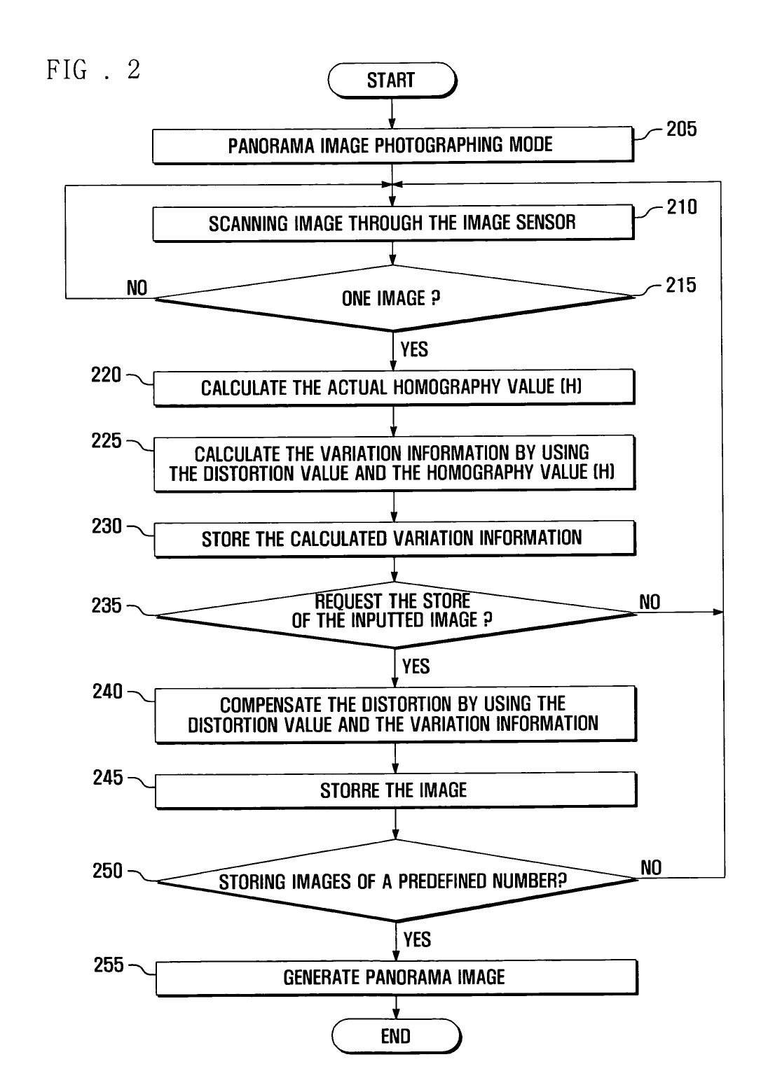

The image processing controller 130 controls the operation of processing an image signal of the image processing unit 120. Particularly, the image processing controller 130 calculates an actual homography value between the input current image and the adjacent picture that previously input using the panoramic shot mode. The calculated homography value, including the variation information, is set up. Thereafter, the variation information, which has a minimum difference between the actual homography value and the calculation homography value, is calculated. Moreover, the image processing controller 130 estimates a distortion value D, included in the inputted image, from an original image estimated as an image which does not include distortion. At this time, the estimated distortion value D is also comprised of the variation information. If the image processing controller 130 stores the variation information obtained like this and is requested to store the inputted image, the image processing controller 130 compensates for the distortion included in the inputted image by using the distortion value and the variation information. Moreover, the image processing controller 130 generates the panoramic image by performing a registration and a blending, if the number of the stored images equals a number of preset images, as a panorama image. For this, the image processing controller 130 can include a motion estimation unit 132, which estimates the distortion value and calculates the variation information between two successive images, and a distortion compensating unit 134, which compensates the distortion included in image by using the variation information accumulated in the image storage and the distortion value D. The storage 140 stores data used for the image processing. For example, the storage 140 stores the distortion value calculated by the motion estimation unit 132, the variation information, the image previously inputted, and the images for the generation of panorama image. The process of compensating for the image distortion of the present invention by the configurations of FIG. 1 is illustrated in detail with reference to FIGS. 2 to 4.

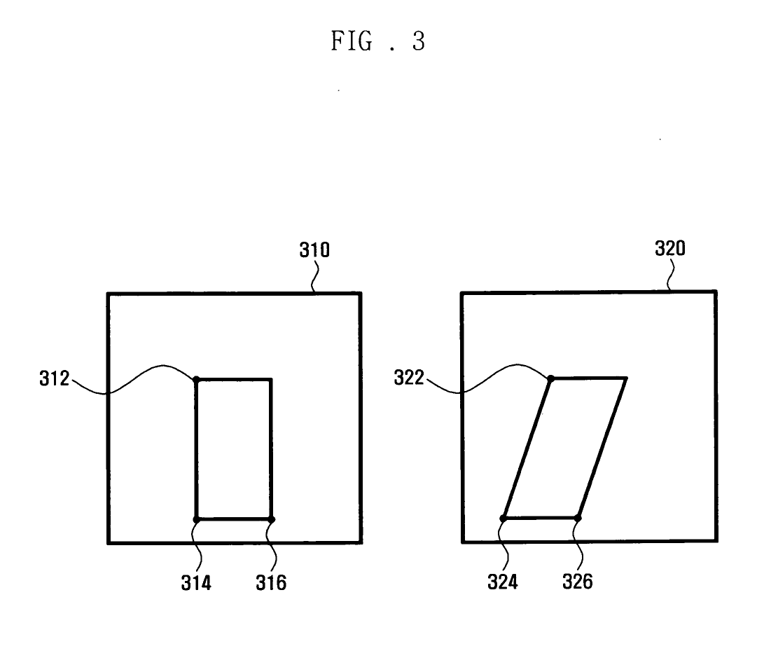

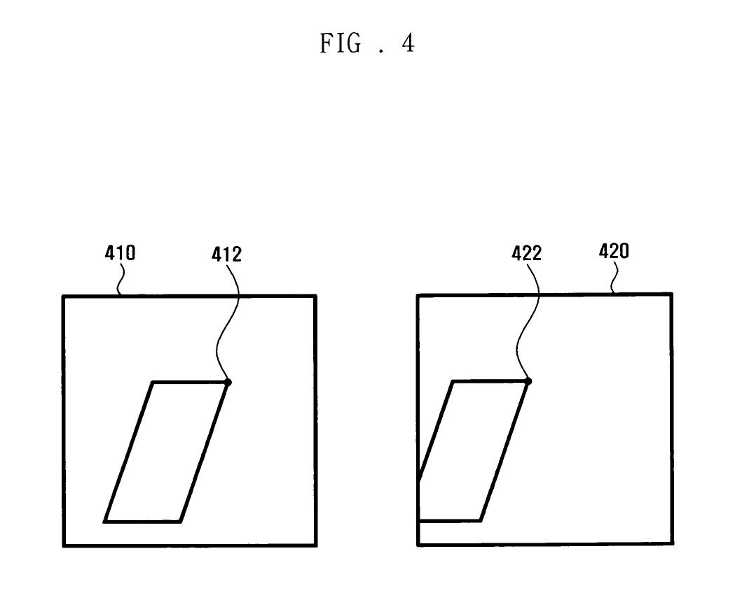

FIG. 2 illustrates a flowchart for a process of compensating a distortion of image according to an exemplary embodiment of the present invention. FIG. 3 is an exemplary diagram of an image that includes distortion and an image that does not include distortion. FIG. 4 is an exemplary diagram of images according to an elapse of time.

Referring to FIGS. 2 to 4, when in the panoramic image photographing mode (step 205), the image processing controller 130 scans an image through the image sensor 110 (step 210). Accordingly, the scanned image signal is input through the image sensor 110. The image processing controller 130 checks whether the inputted image signal becomes one image (step 215). Here, the one image means an image of one frame which is a unit for processing image.

If the inputted image signal becomes one image, the image processing controller 130 proceeds to step 220, and if not, it returns to step 210 and continuously receives the image signal input. The image processing controller 130, particularly, the motion estimation unit 132, calculates the actual homography value (h) (step 220) by comparing the inputted image with the previous image. Here, the actual homography value (h) can be calculated on a real time basis in the overlapped area through a least square optimization method using the matching of a corner or a line feature. Since the method for calculating the actual homography value (h) is a publicly known technology, the detailed description is omitted. The actual homography value (h) calculated similar to this is used when a value of minimum difference with a homography value (H) for calculating later is obtained.

Moreover, after calculating the distortion value (D) included in the original image by using the distorted model, the present invention obtains an original image in which distortion is compensated for by performing reverse transformation on the distortion value (D) in the image in which distortion is included. After setting up the homography value (H) by using the distortion value (D), the variation information can be obtained from the relation of such distortion value (D) and the homography value (H).

Accordingly, the image processing controller 130, particularly, the motion estimation unit 132, calculates the variation information by using the distortion value D and the homography value (H) (in step 225). The relation of the distortion value D, the variation information, and the homography value (H) is described below. The image of the CMOS sensor is obtained by recognizing each pixel value through a progressive scanning method of scanning with a pixel unit or a line unit. As described above, due to this CMOS sensor characteristic, a time for recognizing the pixel value is different according to the location on the CMOS sensor in the obtaining of image. That is, the one image is consisted of pixel values recognized while having a time difference with pixel values recognized by a first scanning, pixel values recognized by a second scanning, and pixel values recognized by a third scanning. Therefore, in the case of image by the CMOS sensor, the recognized image can include distortion in comparison with another case, that is, when a image captured by a sensor in which all pixel values comprising one image by one scanning is recognized, such as, for example, when the image is captured by the CCD sensor. That is, in case the location at the point of time of first scanning is different from the location at the point of time of N-th scanning, the pixel values recognized in different locations compose one image. Therefore, distortion is caused. It is assumed that the image coordinates obtained through the CCD is X. It is assumed that the sensor moves to the x-axis as much as tx and moves to the y-axis as much as ty. It is assumed that the pixel size of the longitudinal axis (Y-axis) is Y. If the image coordinates obtained through the CMOS sensor, that is, the image sensor 110 is X^{d}, the distortion value D can be expressed like below Equation 1. In the present invention, since the variation between the images successively photographed in the real-time photographing is not large, it is assumed that it is approximated only to two dimension movement values, that is, to the movement values for the x-axis and the y-axis.

Here, it is an example of image in which that the image obtained through the CCD sensor does not include the estimated distortion, and an example of image in which that the image obtained through the CMOS sensor includes distortion.

$${X}^{d} = ( \begin{matrix}{x}^{d} \\ {y}^{d} \\ 1\end{matrix} ) = ( \begin{matrix}1 & - \frac{{t}_{x}}{Y + {t}_{y}} & 0 \\ 0 & - \frac{Y}{Y + {t}_{y}} & 0 \\ 0 & 0 & 1\end{matrix} ) ( \begin{matrix}x \\ y \\ 1\end{matrix} ) = DX \qquad [ Eqn . 1 ]$$

In the Equation 1, in order to calculate the distortion value (D), the variation function (T), consisting of movement values, tx and ty, can be modeled like below Equation 2. Here, it is assumed that the movement values (tₓ, t_{y}) is variation information.

Considering that the homography value is 3×3 matrix, the distortion value D is also modeled with 3×3 matrix and, accordingly, the variation function T is also modeled to be 3×3 matrix.

$$T = [ \begin{matrix}1 & 0 & {t}_{x} \\ 0 & 1 & {t}_{y} \\ 0 & 0 & 1\end{matrix} ] \qquad [ Eqn . 2 ]$$

Here, tₓ is the movement value that sensor moves to the x-axis, and t_{y} is the movement value that sensor moves to the y-axis. In order to calculate the above-described distortion value D and the variation information, the present invention uses the homography model (H), which indicates a correspondence relation between two images. As for the homography model (H) using the relation of the points corresponding to two images, the two images are successive images and uses the image at the time t and the image at time t+1. Here, it is assumed that the image at time t+1 is an image that currently is input and the image at time t is a previous image.

The coordinate of image having no distortion (hereinafter, ‘original image’) is assumed by using the variation function (Tt) at the time t from the above Equation 2. More particularly, assuming that the coordinate of the previous original image corresponding to the previous image is Xt and the coordinate of the current original image corresponding to the current image is Xₜ₊₁, the distorted current image and the coordinate of the previous image Xₜ^{d} and Xₜ₊₁^{d} from Equation 1 and Equation 2 can be expressed like below Equation 3:

Xₜ₊₁^{d}=Hₜ^{t+1}Xₜ^{d}=Dₜ₊₁Tₜ(Dₜ)⁻¹Xₜ^{d} [Eqn. 3]

Here, Dₜ is an image of the t point of time, that is, a distortion value of the previous image. Dₜ₊₁ is an image of the t+1 point of time, that is, a distortion value of the current image. As described above, the homography value (H) can be expressed by using the distortion value (D) and variation function. In detail, the homography value (H) is expressed by using the distortion value (D) and variation information like below Equation 4. As assumed in the above case, two images are an image at the t point of time and an image at the t+1 point of time, the homography (Hₜ^{t+1}) between two images can be expressed with 3×3 matrix from Equation 1 to Equation 3.

$${H}_{t}^{t + 1} = [ \begin{matrix}1 & {a}_{t}^{t + 1} & {b}_{t}^{t + 1} \\ 0 & {c}_{t}^{t + 1} & {d}_{t}^{t + 1} \\ 0 & 0 & 1\end{matrix} ] [ \begin{matrix}1 & \frac{{t}_{x}^{t}}{Y} - \frac{{t}_{x}^{t + 1} ( Y + {t}_{y}^{t} )}{Y ( Y + {t}_{y}^{t + 1} )} & - {t}_{x}^{t} + \frac{{t}_{x}^{t + 1} {t}_{y}^{t}}{Y + {t}_{y}^{t + 1}} \\ 0 & \frac{Y + {t}_{y}^{t}}{Y + {t}_{y}^{t + 1}} & - {t}_{y}^{t} ( 1 - \frac{{t}_{x}^{t + 1} {t}_{y}^{t}}{Y + {t}_{y}^{t + 1}} ) \\ 0 & 0 & 1\end{matrix} ] \qquad [ Eqn . 4 ]$$

Here, tₓ^{t} is the movement value moved to the x-axis at the t point of time, tₓ^{t+1} is the movement value moved to the x-axis at the t+1 point of time, t_{y}^{t} is the movement value moved to the y-axis at the t point of time, t_{y}^{t+1} is the movement value moved to the y-axis at the t+1 point of time. Moreover, Y expresses the pixel size of y-axis of image. The variation information (tₓ^{t}, tₓ^{t+1}, t_{y}^{t}, t_{y}^{t+1}) obtained through Equation 1 to Equation 4 can be obtained through the actual homography value (H) obtained at step 220 and the value in which the homography value (Hₜ^{t+1}) is minimized. This relation is expressed in below Equation 5.

Here, assuming that the actual homography is htt+1, as shown in below Equation 5, the variation information (tₓ^{t+1}, t_{y}^{t+1}) of the current image can be calculated by the least square optimization method using the Frobenius norm through using the homography (hₜ^{t+1}, Hₜ^{t+1}).

$$( {\hat{t}}_{x}^{t + 1} , {\hat{t}}_{y}^{t + 1} ) = arg {min}_{{t}_{x}^{t + 1} , {t}_{y}^{t + 1}} {\vert {h}_{t}^{t + 1} - {H}_{t}^{t + 1} \vert}_{F} \qquad [ Eqn . 5 ]$$

Here, \hat{t}_{X}^{t+1} is an estimated value of tₓ^{t+1}, and \hat{t}_{y}^{t+1} is an estimated value of t_{y}^{t+}1.

Returning to FIG. 2, the image processing controller 130, particularly, the motion estimation unit 132, accumulates and stores the variation information which is calculated through Equation 1 to Equation 5 (step 230). The image processing controller 130 checks the request for storing the current image (step 235).

At this time, the method for inputting a store request includes an auto store request method and a manual store request method. The auto store request method is a method that checks the extent of overlapping of the previously stored image and the current image by using the calculated variation information, requests a storage by automatically determines the storage of the current image in case the previously stored image and the current image are overlapped with a predefined amount. Alternatively, the manual store request method is a method that requests an image store through a store signal by user.

Hereinafter, in the present invention, it is assumed that the storage of image is determined and requested by the auto store request method which is generally used in the panorama image photographing. Moreover, in this case, the image processing controller 130 can additionally perform a process of checking the extent of overlapping of the previously stored image and the current image by using the calculated variation information at step 235.

The image processing controller 130 proceeds to step 240 in case of storing the current image. If not, it returns to step 210. The image processing controller 130 compensates the distortion of the current image which is to be stored by using the variation information accumulated (step 240). In the present invention, the distortion compensation is not performed with respect to every inputted image for the efficient performance of the distortion compensation, but stores by obtaining the variation information by the above described process. Thereafter, when the storing for the inputted image is requested, the obtained variation information, as described above, is used to compensate a corresponding image by using the relation of above Equation 3 and below Equation 6 and stored. Below Equation 6 expresses the relation of the distorted image and the original image.

Iₜ(Xₜ)=Iₜ^{d}(Xₜ^{d})=Iₜ^{d}(DₜXₜ) [Eqn. 6]

Here, the Iₜ(Xₜ) indicates an image which is consisted of the coordinate Xₜ and not distorted, the Iₜ^{d}(Xₜ^{d}) indicates the distorted image consisting of the coordinate Xₜ^{d}. The image processing controller 130 stores the image in which distortion is compensated through Equation 6 into the storage 140 (step 245). The image processing controller 130 checks whether the number of stored images meets the number of images composing one panorama image (step 250). Since one panoramic image is composed of the images of a predefined number, the image processing controller 130 checks whether the number of stored images satisfies the composition of one panoramic image. When the number of stored images equals a predefined number, the image processing controller 130 proceeds to step 255, and, if not, it returns to step 210. The image processing controller 130 generates one panoramic image by images stored in the storage 140 (step 255).

At this time, each image composing the generated panorama image is an image in which the distortion included in the image is compensated. Moreover, the panoramic image can be generated by a typical method. Therefore, the homography calculation which is generally calculated in the generation of panoramic image can be additionally performed. Thus, since the distortion of the stored images is already compensated, the present invention can increase the accuracy in the general homography calculation for the generation of panorama image. Explaining it again with reference to the exemplary diagrams of FIGS. 3 to 4, a distortion-free image 310 of FIG. 3 is an example of image that does not include distortion depending on the movement like the CCD sensor, a distorted image 320 is an example of image which includes distortion depending on the movement like the CMOS sensor. When two images 310, 320 take a picture of the same object, such as a pillar, the upper point of left side 312 of the pillar in the distortion-free image 310 can be associated to the upper point of left side 322 of the pillar in the distorted image 320. Since the distorted image 320 is an image obtained by the sensor having a time difference in the recognition of pixel, as shown in FIG. 3, lower end points 324, 326 of the distorted image 320 are distorted compared with corresponding lower end points 314, 316 of the distortion-free image 310. That is, the pillar in the distorted image 320 is distorted with a slant form not with a rectangular form like the distortion-free image 310. The present invention controls the distortion value (D) in the distorted image 320 by obtaining the distortion value (D), which is added to the distortion-free image 310 and distorts like the distorted image 320, so that the present invention compensates the distortion of the distorted image 320. This relation is expressed in the above Equation 1. Here, the coordinate in the distortion-free image 310 is X, the coordinate in the distorted image 320 is X^{d}. The homography uses corresponding points of two successive images in order to calculate the distortion value (D). At this time, the example of two successive images is illustrated in FIG. 4. In FIG. 4, the image 410 is an example of image at the t point in time, that is, an example of the previous image, the image 420 is an example of image at the t+1 point in time, that is, an example of the current image. The coordinate of the corresponding point at the image 410 can be Xₜ^{d}, the coordinate of the corresponding point at the image 420 can be Xₜ₊₁^{d}. For example, the coordinate of the upper point of right side 412 of the pillar of the image 410 can be Xₜ^{d}, the coordinate of the upper point of right side 422 of the pillar in the corresponding image 420 can be Xₜ₊₁^{d}. If the coordinates of the corresponding points in the image 410 and image 420 are assumed like this, it can be expressed like the above Equation 3. The movement values of the x-axis and the y-axis are utilized so as to calculate the coordinates Xₜ^{d}, Xₜ₊₁^{d}. The homography value that can be expressed in terms of movement values is used to calculate movement value. This was described herein above in the above Equation 4 and 5. Like this, movement values, that is, the variation information can be obtained. The distortion of the image 320 of FIG. 3 can be compensated through Equation 3 and Equation 6 like the image 310 by using the variation information obtained like this. As described above, when moving a terminal equipped with a camera module from side to side or up and down by user so as to automatically generate the panoramic image, the extent of overlapping between images is calculated by using the accumulated variation information, and then, if the overlapping is made to the extent that is predefined, the image is automatically stored. At this time, the movement of the image sensor can be easily approximated to the variation function which is given by Equation 2 with respect to successively photographed image. The present invention can obtain movement values, which are more exact than conventional calculating methods, by using the distortion value and the homography model in the process of calculating movement values composing the variation function. Moreover, in the panoramic image generation algorithm, the distortion compensation is required only for the image to be stored. Thus, a compensated image is generated through Equation 6 only for the image to be stored. In this way, the distortion compensation process can be efficiently performed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of compensating an image distortion, the method comprising:
receiving a current image including distortion caused by an movement of a sensor in a mode where two or more successive images are received;
calculating variation information using a relation between corresponding points of the current image and a previous image which was previously received; and
compensating the distortion included in the current image by making use of the variation information.

2. The method of claim 1, wherein calculating variation information comprises:
calculating an actual homography value between the current image and the previous image;
setting up the calculation based homography value including the variation information; and
obtaining variation information having a minimum difference between the actual homography value and the calculation based homography value.

3. The method of claim 2, wherein the variation information comprises two dimension movement values which are moved from the previous image to the current image in an arbitrary point of time.

4. The method of claim 2, wherein the movement values is a value (tx) obtained by moving to x-axis and a value (ty) obtained by moving to y-axis in an arbitrary point of time by the sensor.

5. The method of claim 3, wherein the calculation based homography (Hₜ^{t+1}) is obtained through an with a 3×3 matrix, the equation defined as:
$${H}_{t}^{t + 1} = [ \begin{matrix}1 & \frac{{t}_{x}^{t}}{Y} - \frac{{t}_{x}^{t + 1} ( Y + {t}_{y}^{t} )}{Y ( Y + {t}_{y}^{t + 1} )} & - {t}_{x}^{t} + \frac{{t}_{x}^{t + 1} {t}_{y}^{t}}{Y + {t}_{y}^{t + 1}} \\ 0 & \frac{Y + {t}_{y}^{t}}{Y + {t}_{y}^{t + 1}} & - {t}_{y}^{t} ( 1 - \frac{{t}_{x}^{t + 1} {t}_{y}^{t}}{Y + {t}_{y}^{t + 1}} ) \\ 0 & 0 & 1\end{matrix} ] ,$$
where, tₓ^{t} is a movement value that the sensor moved to x-axis in the previous image, tₓ^{t+1} is a movement value that the sensor moved to x-axis in the current image, t_{y}^{t} is a movement value that the sensor moved to y-axis in the previous image, t_{y}^{t+1} is a movement value that the sensor moved to y-axis in the current image, and Y is a pixel size of y-axis of the images.

6. The method of claim 5, wherein calculating variation information comprises:
estimating a distortion value (D) included in the current image from an original image estimated as a distortion-free image which does not include the distortion; and
calculating the calculated homography value (Hₜ^{t+1}) by making use of a variation function consisting of the distortion value (D) and the movement values.

7. The method of claim 6, wherein the homography value (Hₜ^{t+1}), the distortion value (D) and the movement values is defined by: Xₜ₊₁^{d}=Hₜ^{t+1}Xₜ^{d}=Dₜ₊₁Tₜ(Dₜ)⁻¹Xₜ^{d},
where Xₜ₊₁^{d} is a coordinate of the current image, Xₜ^{d} is a coordinate of the previous image, Dₜ₊₁ is a distortion value of the current image, Dₜ is a distortion value of the previous image, and Tₜ is a variation function at t point of time.

8. The method of claim 7, wherein the distortion value (D) is defined by:
$${X}^{d} = ( \begin{matrix}{x}^{d} \\ {y}^{d} \\ 1\end{matrix} ) = ( \begin{matrix}1 & - \frac{{t}_{x}}{Y + {t}_{y}} & 0 \\ 0 & - \frac{Y}{Y + {t}_{y}} & 0 \\ 0 & 0 & 1\end{matrix} ) ( \begin{matrix}x \\ y \\ 1\end{matrix} ) = DX ,$$
where X^{d} is a coordinate of the current image, x^{d} is x-axis coordinate of the current image, y^{d} is y-axis coordinate of the current image, X is a coordinate of the original image, x is x-axis coordinate of the original image, y is y-axis coordinate of the original image, tₓ is a value that the sensor moves to x-axis, t_{y} is a value that the sensor moves to y-axis, and Y is a pixel size of y-axis of the images,
wherein the variation function T is defined by:
$$T = [ \begin{matrix}1 & 0 & {t}_{x} \\ 0 & 1 & {t}_{y} \\ 0 & 0 & 1\end{matrix} ] , and$$
where tₓ is a value that the sensor moves to x-axis, t_{y} is a value that the sensor moves to y-axis.

9. The method of claim 2, wherein the variation information having a minimum difference between the actual homography value and the calculation based homography value is calculated through a least square optimization method by Frobenius norm of the actual homography (Hₜ^{t+1}) and the calculation based homography (Hₜ^{t+1}).

10. The method of claim 2, wherein the actual homography value is obtained using of a matching of predefined features in an overlapped region of the previous image and the current image.

11. The method of claim 1, wherein the distortion compensation is performed when the current image is stored.

12. The method of claim 1, wherein the mode where two or more successive images are received is a panoramic image photographing mode.

13. The method of claim 1, further comprising:
Storing, after the distortion is compensated, a distortion compensated image;
comparing a number of the stored image with a predefined number; and
generating a panorama image from the stored images, when the number of image is a predefined number.

14. An apparatus for compensating an image distortion, the apparatus comprising:
a sensor configured to scan an image with a temporal interval, in a mode where two or more successive images are received;
an image processing unit configured to receive a current image including distortion by a movement of the sensor and to process the distortion image with a frame unit;
an image processing controller configured to calculate variation information by making use of a relation between corresponding points of the current image and a previous image which was previously received, and to compensate the distortion included in the current image by making use of the variation information; and
a storage configured to store at least one storing requested image, the previous image, the distortion value and the variation information.

15. The apparatus of claim 14, wherein the image processing controller calculates the variation information by calculating an actual homography value between the current image and the previous image, setting up the calculation based homography value including the variation information, and then, calculating variation information having a minimum difference between the actual homography value and the calculation based homography value.

16. The apparatus of claim 15, wherein the variation information comprises two dimension movement values which are moved from the previous image to the current image in an arbitrary point of time.

17. The apparatus of claim 16, wherein the movement values is a value (tx) obtained by moving to x-axis and a value (ty) obtained by moving to y-axis in an arbitrary point of time by the sensor.

18. The apparatus of claim 16, wherein the image processing controller obtains the calculation based homography (Htt+1) through an equation with a 3×3 matrix, the equation defined as:
$${H}_{t}^{t + 1} = [ \begin{matrix}1 & \frac{{t}_{x}^{t}}{Y} - \frac{{t}_{x}^{t + 1} ( Y + {t}_{y}^{t} )}{Y ( Y + {t}_{y}^{t + 1} )} & - {t}_{x}^{t} + \frac{{t}_{x}^{t + 1} {t}_{y}^{t}}{Y + {t}_{y}^{t + 1}} \\ 0 & \frac{Y + {t}_{y}^{t}}{Y + {t}_{y}^{t + 1}} & - {t}_{y}^{t} ( 1 - \frac{{t}_{x}^{t + 1} {t}_{y}^{t}}{Y + {t}_{y}^{t + 1}} ) \\ 0 & 0 & 1\end{matrix} ] ,$$
where txt is a movement value that the sensor moved to x-axis in the previous image, txt+1 is a movement value that the sensor moved to x-axis in the current image, tyt is a movement value that the sensor moved to y-axis in the previous image, tyt+1 is a movement value that the sensor moved to y-axis in the current image, and Y is a pixel size of y-axis of the images.

19. The apparatus of claim 18, wherein the image processing controller estimates a distortion value (D) included in the current image from an image (original image) estimated as an image which does not include the distortion, and calculates the calculated homography value (Htt+1) by making use of a variation function consisting of the distortion value (D) and the movement values.

20. The apparatus of claim 6, wherein the homography value (Htt+1), the distortion value (D) and the movement values is defined by:
Xₜ₊₁^{d}=Uₜ^{t+1}Xₜ^{d}=Dₜ₊₁Tₜ(Dₜ)⁻¹Xₜ^{d}
where Xt+1d is a coordinate of the current image, Xtd is a coordinate of the previous image, Dt+1 is a distortion value of the current image, Dt is a distortion value of the previous image, and Tt is a variation function at t point of time.

21. The apparatus of claim 20, wherein the distortion value (D) is defined by:
$${X}^{d} = ( \begin{matrix}{x}^{d} \\ {y}^{d} \\ 1\end{matrix} ) = ( \begin{matrix}1 & - \frac{{t}_{x}}{Y + {t}_{y}} & 0 \\ 0 & - \frac{Y}{Y + {t}_{y}} & 0 \\ 0 & 0 & 1\end{matrix} ) ( \begin{matrix}x \\ y \\ 1\end{matrix} ) = DX ,$$
where xd is a coordinate of the current image, xd is x-axis coordinate of the current image, yd is y-axis coordinate of the current image, X is a coordinate of the original image, x is x-axis coordinate of the original image, y is y-axis coordinate of the original image, tx is a value that the sensor moves to x-axis, ty is a value that the sensor moves to y-axis, and Y is a pixel size of y-axis of the images, and
wherein the variation function T is defined by:
$$t = [ \begin{matrix}1 & 0 & {t}_{x} \\ 0 & 1 & {t}_{y} \\ 0 & 0 & 1\end{matrix} ]$$
where tx is a value that the sensor moves to x-axis, ty is a value that the sensor moves to y-axis

22. The apparatus of claim 14, wherein the image processing controller compensates distortion included in the current image, when the current image is stored.

23. The apparatus of claim 14, wherein the sensor is a CMOS sensor.
